(19) United States
(12) Patent Application Publication
(10) Pub. No.: US 2022/0070080 A1
(43) Pub. Date: Mar. 3, 2022

(54) OPEN FRONTHAUL DEVICE

(71) Applicant: KULCLOUD, Seongnam-si, Gyeonggi-do (KR)

(72) Inventors: Seung Yong PARK, Seongnam-si (KR); Seok Hwan KONG, Yongin-si (KR); Dipjyoti SAIKIA, Seongnam-si (KR)

(73) Assignee: KULCLOUD, Seongnam-si, Gyeonggi-do (KR)

(21) Appl. No.: 17/414,919

(22) PCT Filed: Dec. 16, 2018
(86) PCT No.: PCT/KR2018/015966

§ 371 Date: Jun. 16, 2021

(51) Int. Cl. H04L 12/751; H04L 12/12; H04L 12/715; H04L 12/713

(52) U.S. Cl. CPC H04L 45/02; H04L 12/12; H04L 45/04; H04L 45/586; H04L 45/64

(57) ABSTRACT

The present invention relates to an open fronthaul device and a network system including same, and the open fronthaul device and the network system including same according to the present invention can implement various network functions in software without being vender-dependent, by applying network dis-aggregation to a wired/wireless network.

### TECHNICAL FIELD

The present invention relates to an open fronthaul device and a network system including the same.

### BACKGROUND ART

With the development of mobile communication technologies, following the 4^{th} generation mobile communication technology that processes a large amount of traffics at a high speed, the 5^{th} generation mobile communication technology that connects a large number of devices such as the Internet of Things while processing a large amount of traffics at a high speed with low latency is being developed.

In particular, researches on wired and wireless backhaul, midhaul, and fronthaul are being actively conducted in order to smoothly provide high-speed/low-latency wireless transmission and a simultaneous access service for a large number of devices through a mobile communication access network. However, in order to satisfy such requirements, enormous expense for constructing 5G fronthaul and enormous expense for constructing a huge 5G RAN are required due to the monopoly based on a haul specification that is unique to an existing vender of a radio access network (RAN) device.

Therefore, as in the related art, when the RAN device vender uses a vender's own fronthaul specification, the entry of a new vender is hardly allowed, and enormous expense for constructing 5G RAN is caused by the monopoly of the existing RAN vender. Therefore, a technology capable of implementing various network functions in software without depending on a vender is required.

### DETAILED DESCRIPTION OF THE INVENTION

### Technical Problem

An object of the present invention is to provide an open fronthaul device and a network system, which applies network disaggregation to a wired/wireless network to implement various network functions in software without depending on a vender.

### Technical Solution

According to the present invention, an open fronthaul network system includes:

a plurality of remote radio head (RRH) devices configured to transmit and receive data of a wireless terminal;

a radio access network (RAN) device configured to transmit and receive the data of the wireless terminal to allocate a MAC address to a frame;

a plurality of optical line terminals (OLTs);

a mobile communication core network; and

an open fronthaul device connected to the mobile communication core network,

wherein the open fronthaul device includes: a software defined network (SDN) controller including a plurality of openflow edge switches connected to the RRH device via Ethernet, connected to the RAN device via the Ethernet, or connected to the OLT via a passive optical network (PON), in which the openflow edge switches are configured to acquire information of the openflow edge switches belonging to a switch group; and

a legacy routing container configured to treat a switch group including at least some switches among the switches as a virtual router to generate routing information for a packet introduced into any one switch of the switch group, and

the legacy routing container is configured to map a plurality of network devices, which are connected to the openflow switches configured to generate legacy routing information for a flow processing inquiry message of the controller based on information of at least one virtual router, with information of an external network that is directly connected to the virtual router.

In addition, according to the present invention, an open fronthaul device includes: a software defined network (SDN) controller including a plurality of openflow edge switches connected to a plurality of legacy networks, which are wireless access networks or wired access networks, in which the openflow edge switches are configured to acquire information of the openflow edge switches belonging to a switch group; and

a legacy routing container configured to treat a switch group including at least some switches among the switches as a virtual router to generate routing information for a packet introduced into any one switch of the switch group,

wherein the legacy routing container is configured to map a plurality of network devices, which are connected to the openflow switches configured to generate legacy routing information for a flow processing inquiry message of the controller based on information of at least one virtual router, with information of an external network that is directly connected to the virtual router.

### Advantageous Effects

According to the present invention, the open fronthaul device and the network system including the same may apply network disaggregation to a wired/wireless access network both nominally and virtually based on a software defined network (SDN) to abstract an RAN protocol layer while separating a BBU from an RRH for the radio access network, may provide mutual compatibility with an existing vender lock-in protocol through service chaining for each access device, and may divide a function in various manners based on open hardware/software.

### DESCRIPTION OF THE DRAWINGS

FIG. 1 is a block diagram showing an open fronthaul network system according to one embodiment of the present invention.

FIG. 2 is a block diagram showing an open fronthaul network system according to another embodiment of the present invention.

FIG. 3 is a block diagram showing an open fronthaul network system according to still another embodiment of the present invention.

FIGS. 4 to 8 are block diagrams showing an SDN controller of the open fronthaul network system of FIGS. 1 to 3.

FIG. 9 shows a field table of a flow entry and an operation table showing an operation type according to a flow entry.

FIG. 10 shows a field table of group and meter tables.

FIG. 11 is a block diagram showing a network system including an integrated routing system according to one embodiment of the present invention.

FIG. 12 is a virtualized block diagram showing the network system of FIG. 11.

FIG. 13 is a block diagram showing an SDN controller according to another embodiment of the present invention.

FIG. 14 is a block diagram showing a legacy routing container according to one embodiment of the present invention.

FIG. 15 is a flowchart showing a method of determining legacy routing for a flow of the SDN controller of FIG. 11.

FIG. 16 is a signal flowchart showing an integrated routing method according to one embodiment of the present invention.

FIG. 17 is a signal flowchart showing an integrated routing method according to another embodiment of the present invention.

FIG. 18 is a flow table according to one embodiment of the present invention.

### MODE FOR INVENTION

Hereinafter, the present invention will be described in more detail with reference to the drawings.

Terms such as first or second may be used to describe various elements, but the elements should not be limited by the terms. The terms are used only to distinguish one element from another element. For example, a first element may be termed as a second element, and similarly, a second element may be termed as a first element, without departing from the scope of the present invention. The term “and/or” includes a combination of a plurality of related listed elements or any one of the related listed elements.

When one element is described as being “connected” or “accessed” to another element, it should be understood that the element may be directly connected or accessed to the other element or may possibly have another element in between. Meanwhile, when one element is described as being “directly connected” or “directly accessed” to another element, it should be understood that no other element exists there between. Further, when a first element and a second element on a network are connected or accessed to each other, it means that data may be exchanged between the first element and the second element in a wired manner or a wireless manner.

In addition, suffixes “module” and “unit” for elements used in the following description are given in consideration of ease in preparing the present specification only, and do not have a particularly important meaning or role in themselves. Therefore, the “module” and “unit” may be exchangeably used.

When such elements are implemented in an actual application, if necessary, two or more elements may be combined into one element, or one element may be subdivided into two or more elements. Throughout the drawings, identical or similar elements are denoted by the same reference numeral, and detailed descriptions of element shaving the same reference numeral may be omitted and replaced with the description of the previously described element.

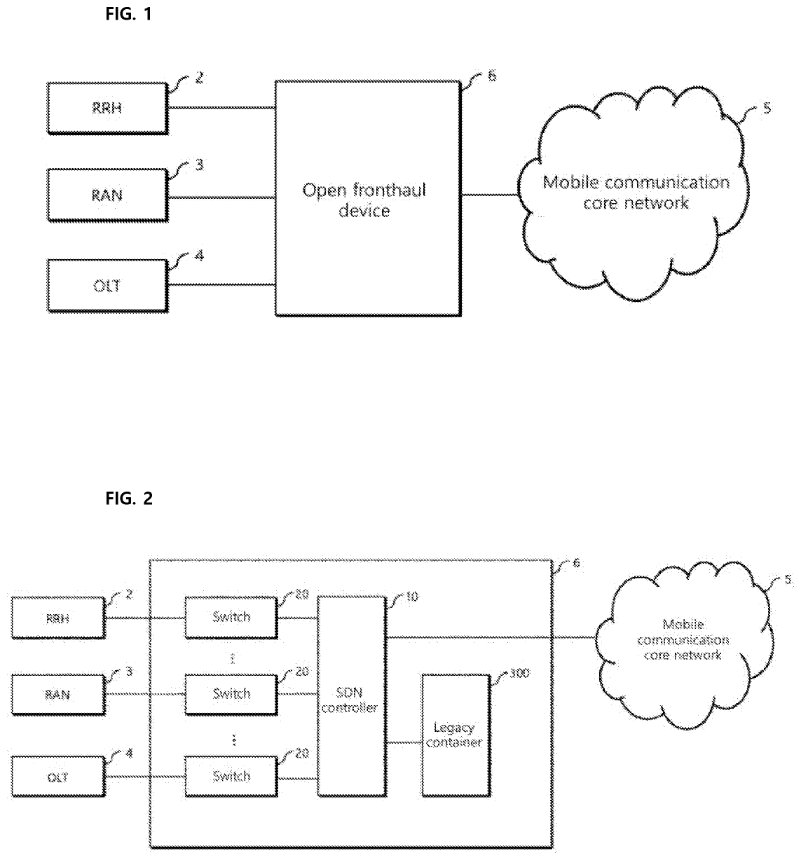

Referring to FIG. 1, according to one embodiment of the present invention, an open fronthaul network system may include: a plurality of remote radio head (RRH) devices 2 configured to transmit and receive data of a wireless terminal; a radio access network (RAN) device 3 configured to transmit and receive data of the wireless terminal to allocate a MAC address to a frame; a plurality of optical line terminals (OLTs) 4; a mobile communication core network 5; and an open fronthaul device 6 connected to the mobile communication core network 5.

Referring to FIG. 2, according to one embodiment of the present invention, the open fronthaul device may include: a software defined network (SDN) controller 10 including a plurality of openflow edge switches 20 connected to the RRH device via Ethernet, connected to the RAN device via the Ethernet, or connected to the OLT via a passive optical network (PON), in which the openflow edge switches 20 are configured to acquire information of the openflow edge switches belonging to a switch group; and a legacy routing container configured to treat a switch group including at least some switches among the switches as a virtual router to generate routing information for a packet introduced into any one switch of the switch group. The legacy routing container 300 may be configured to map a plurality of network devices, which are connected to the openflow switches 20 configured to generate legacy routing information for a flow processing inquiry message of the controller based on information of at least one virtual router, with information of an external network that is directly connected to the virtual router.

The SDN controller 10 is a kind of command computer that controls the SDN system, and may perform various and complex functions, for example, routing, policy declaration, security check, and the like. The SDN controller 10 may define a flow of packets occurring in the switches 20 in a lower layer. The SDN controller 10 may calculate a path (data path) through which the flow is to pass with reference to a network topology and the like for a flow allowed under a network policy, and may set an entry of the flow in the switch on the path. The SDN controller 10 may communicate with the switch 20 by using a specific protocol, for example, an openflow protocol. A communication channel between the SDN controller 10 and the switch 10 may be encrypted by an SSL.

The network device is a physical or virtual device connected to the switch 20, and may be a user terminal device with which data or information is exchanged, or a device that performs a specific function. In view of hardware, the network device 30 may include a PC, a client terminal, a server, a workstation, a supercomputer, a mobile communication terminal, a smartphone, a smart pad, and the like. Further, the network device 30 may be a virtual machine (VM) generated on a physical device. The network device may be referred to as a network function that performs various functions on a network. The network function may include anti-DDoS, intrusion detection/prevention (intrusion detection system/intrusion prevention system; IDS/IPS), an integrated security service, a virtual private network service, anti-virus, anti-spam, a security service, an access management service, a firewall, load balancing, a QoS, video optimization, and the like. Such a network function may be virtualized.

As a virtualized network function, there is network function virtualization (NFV) defined in NFV-related white paper published by European Telecommunications Standards Institute (ETSI). In the present specification, the network function (NF) may be used exchangeably with the network function virtualization (NFV). The NFV may be used to provide a necessary network function by dynamically generating L4-7 service connection required for each tenant, or to rapidly provide a firewall, and IPS and DPI functions required based on the policy through a series of service chaining in a case of a DDoS attack. In addition, the NFV may easily turn on/off the firewall or the IDS/IPS, and may automatically perform provisioning. Further, the NFV may reduce the necessity of over-provisioning.

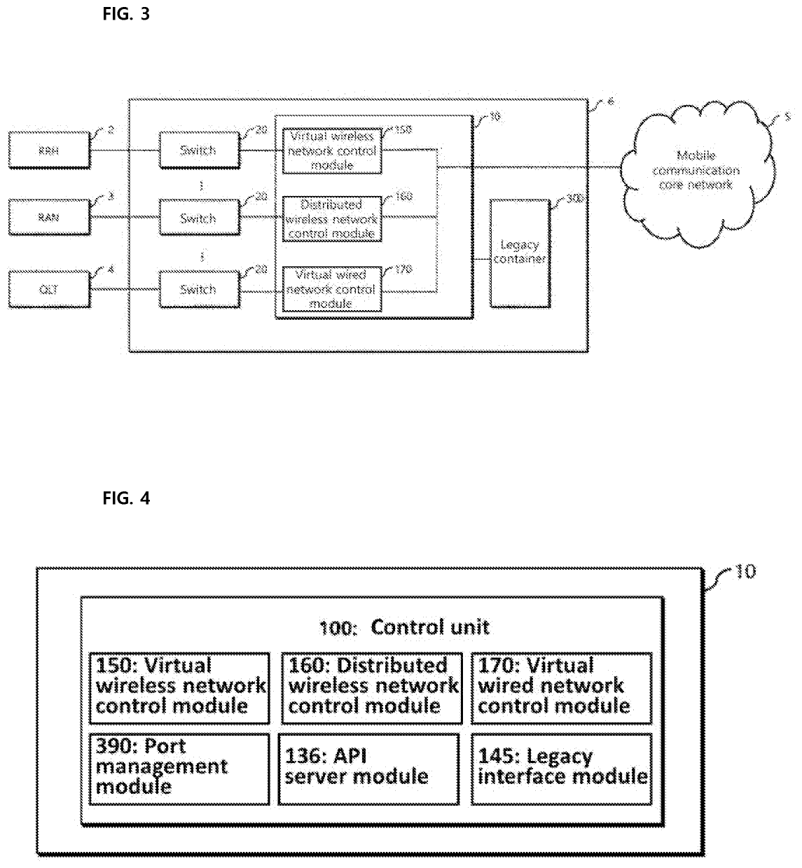

Referring to FIG. 3, according to the present invention, the SDN controller 10 may further include a virtual wireless network control module 150 configured to map an RRH device 2 of the connected wireless access network with the information of the external network that is directly connected to the virtual router.

Referring to FIG. 3, according to the present invention, the SDN controller 10 may further include a distributed wireless network control module 160 configured to map a digital processing unit (digital unit; DU) of the connected wireless access network with the information of the external network that is directly connected to the virtual router.

Referring to FIG. 3, according to the present invention, the SDN controller 10 may further include a virtual wired network control module 170 configured to map an OLT of the connected wired access network with the information of the external network that is directly connected to the virtual router.

Referring to FIG. 4, according to the present invention, the SDN controller 10 may further include: a port management module 390 configured to map a logical port of the switch with a physical port of the switch; a legacy interface module 145 configured to communicate with the legacy routing container; and an API server module 136 configured to perform an operation according to a procedure of changing information of the mapped network device.

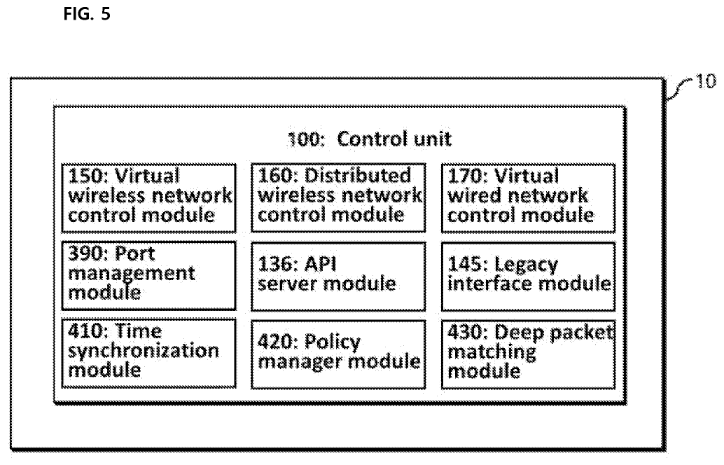

Referring to FIG. 5, according to the present invention, the SDN controller 10 may be configured such that the controller may include: a time synchronization module 410 configured to synchronize a time of the packet with a timestamp value of the network device; a policy manager module 420 configured to control a Quality of Service (QoS); and a deep packet matching module 430 configured to extract, modify, remove, or insert a GTP header or a VxLAN header of a flow packet.

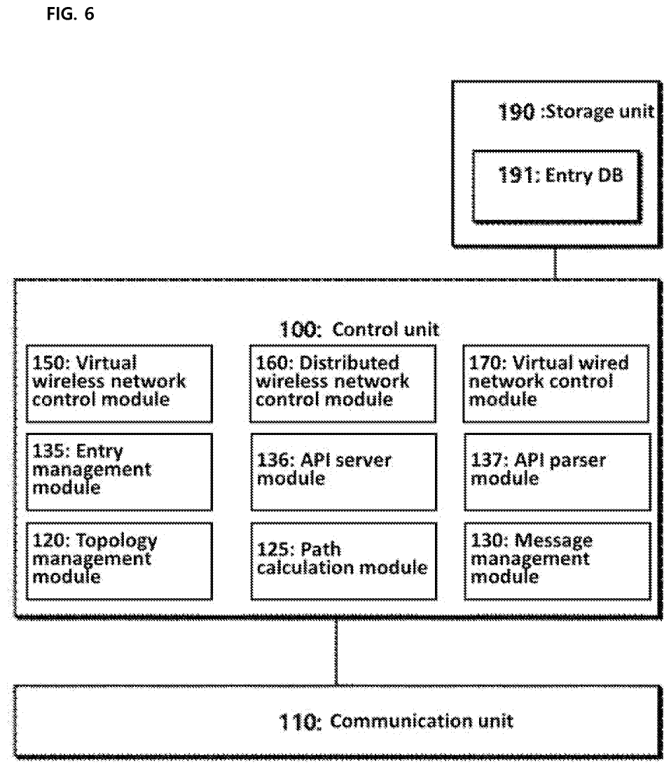

Referring to FIG. 6, the storage unit 190 may store a program for processing and controlling a control unit 100. The storage unit 190 may perform a function of temporarily storing input or output data (a packet, a message, etc.). The storage unit 190 may include an entry database (DB) 191 configured to store the flow entry.

The control unit 100 may control an overall operation of the SDN controller 10 by controlling an operation of each of the units. The control unit 100 may include a topology management module 120, a path calculation module 125, an entry management module 135, an API server module 136, an API parser module 137, and a message management module 130. Each of the modules may be configured as hardware within the control unit 100, or may be configured as software separate from the control unit 100.

The topology management module 120 may construct and manage network topology information based on access relation of the switch 20 collected through the switch communication unit 110. The network topology information may include a topology between switches and a topology of a network device connected to each of the switches.

The path calculation module 125 may calculate a data path of a packet received through the switch communication unit 110 and an action column executed by a switch on the data path based on the network topology information constructed by the topology management module 120.

The entry management module 135 may register entries of a flow table, a group table, a meter table, and the like in an entry DB 191 based on a result calculated by the path calculation module 125, a policy of a QoS and the like, a user instruction, and the like. The entry management module 135 may register the entry of each of the tables in the switch 20 in advance (proactive), or may respond to a request for adding or updating the entry from the switch 20 (reactive). The entry management module 135 may change or delete the entry of the entry DB 191 if necessary or by an entry extinction message of the switch 20.

The API parser module 137 may interpret a procedure of changing information of a mapped network device.

The message management module 130 may interpret a message received through the switch communication unit 110 or generate an SDN controller-to-switch message, which will be described below, transmitted to the switch through the switch communication unit 110. A modify state message, which is one of SDN controller-to-switch messages, may be generated based on the entry according to the entry management module 135, or the entry stored in the entry DB 191.

The switch 20 may be a physical switch or a virtual switch that supports the openflow protocol. The switch 20 may process the received packet to relay a flow between the network devices 30. To this end, the switch 20 may include one flow table or multiple flow tables for pipeline processing.

The flow table may include a flow entry that defines a rule of processing a flow of the network device 30.

In view of one switch, the flow may refer to a series of packets that share a value of at least one header field, or a packet flow of a specific path according to a combination of several flow entries of multiple switches. The openflow network may perform path control, failure recovery, load distribution, and optimization in a unit of flow.

The switch 20 may be divided into edge switches on inlet and outlet sides of the flow (an ingress switch and an egress switch) according to a combination of multiple switches, and a core switch between the edge switches.

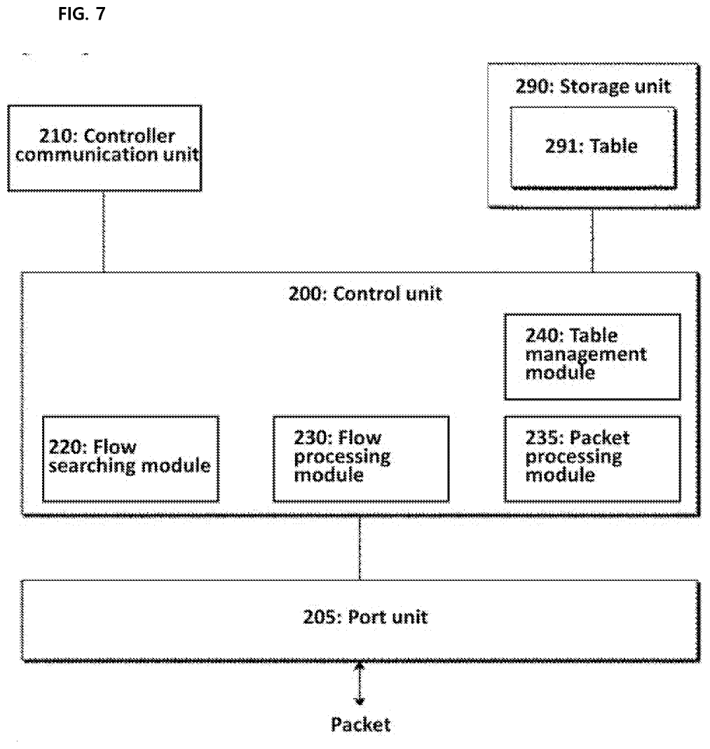

Referring to FIG. 7, the switch 20 may include: a port unit 205 configured to communicate with another switch and/or a network device; an SDN controller communication unit 210 configured to communicate with the SDN controller 10; a switch control unit 200; and a storage unit 290.

The port unit 205 may include a plurality of pairs of ports for entering and exiting the switch or the network device. The pair of ports may be implemented as one port.

The storage unit 290 may store a program for processing and controlling the switch control unit 200. The storage unit 290 may perform a function of temporarily storing input or output data (a packet, a message, etc.). The storage unit 290 may include a table 291 such as a flow table, a group table, and a meter table. The table 291 or an entry of the table may be added, modified, or deleted by the SDN controller 10. The table entry may be destroyed by itself.

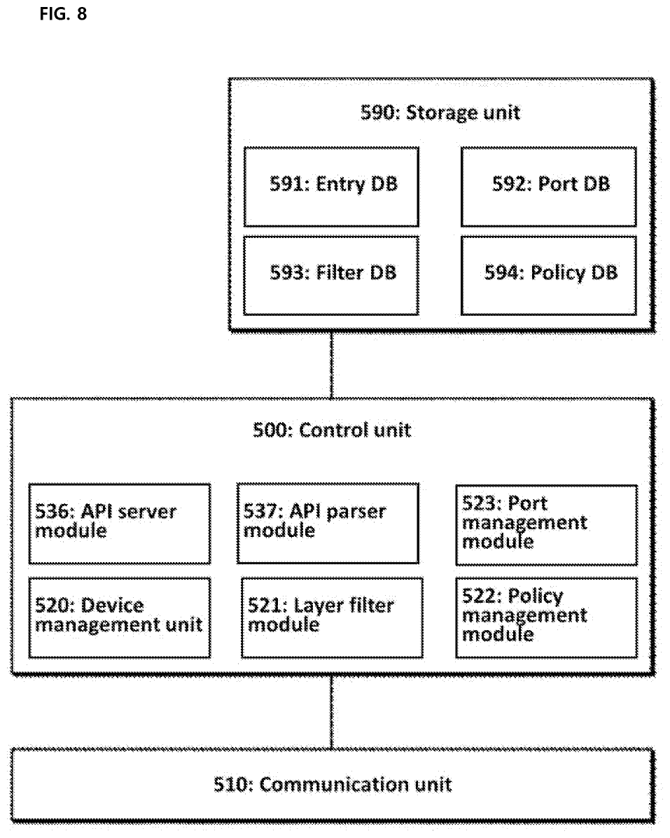

Referring to FIG. 8, a TAP application 50 may include a control unit 500, a communication unit 510 configured to communicate with the SDN controller 10, and a storage unit 590.

The control unit 500 may include a layer filter module 521, a policy management module 522, a port management module 523, an API server module 536, and an API parser module 537.

The storage unit 590 may include an entry DB 591, a port DB 592, a filter DB 593, and a policy DB 594.

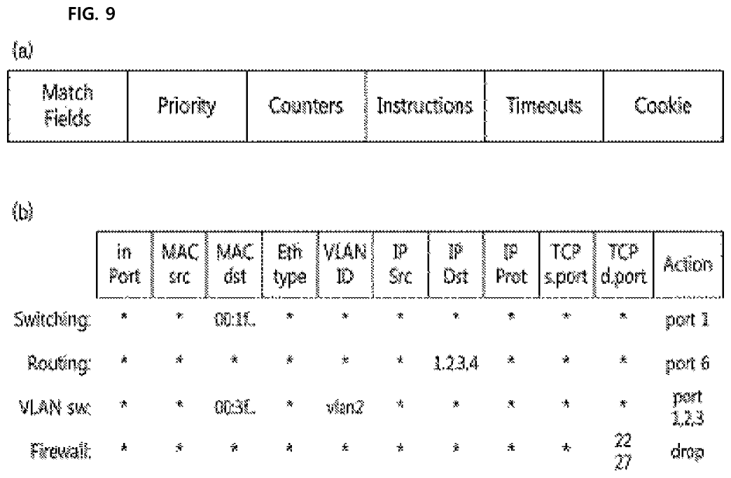

The flow table may be configured as multiple flow tables for pipeline-processing an openflow. Referring to FIG. 9, the flow entry of the flow table may include a tuple such as: match fields that describe a condition (a comparison rule) matching a packet; a priority; counters which are updated when there is a matching packet; an instruction that is a set of various actions generated when there is a matching packet in the flow entry; timeouts that describe a time at which the flow entry is destroyed in the switch; and a cookie that is an opaque type selected by the SDN controller, and is used by the SDN controller to filter flow statistics, a flow change, and flow deletion without being used upon packet processing. The instruction may perform a change of the pipeline processing, such as forwarding a packet to another flow table. In addition, the instruction may include a set of actions that adds an action to an action set, or a list of actions to be immediately applied to a packet. The action refers to an operation of modifying a packet, such as an operation of transmitting a packet to a specific port or reducing a TTL field. The action may belong to a part of an instruction set associated with a flow entry or an action bucket associated with a group entry. The action set refers to a set obtained by accumulating actions indicated in each of the tables. The action set may be executed when there is no matching table. FIG. 9 illustrates several packet processing by the flow entry.

Pipeline refers to a series of packet processing processes between a packet and a flow table. When the packet flows into the switch 20, the switch 20 may search for a flow entry that matches the packet in an order of a high priority in a first flow table. When the matching is successful, an instruction of the entry may be executed. The instruction may include: a command that is executed immediately when the matching is successful (apply-action); a command for deleting or adding/modifying a content of an action set (clear-action; write-action); a metadata modification command (write-metadata); and a goto command that moves a packet to a designated table together with metadata (goto-table). When there is no flow entry that matches the packet, the packet may be dropped or may be loaded on a packet-in message so as to be forwarded to the SDN controller 10 depending on table setting.

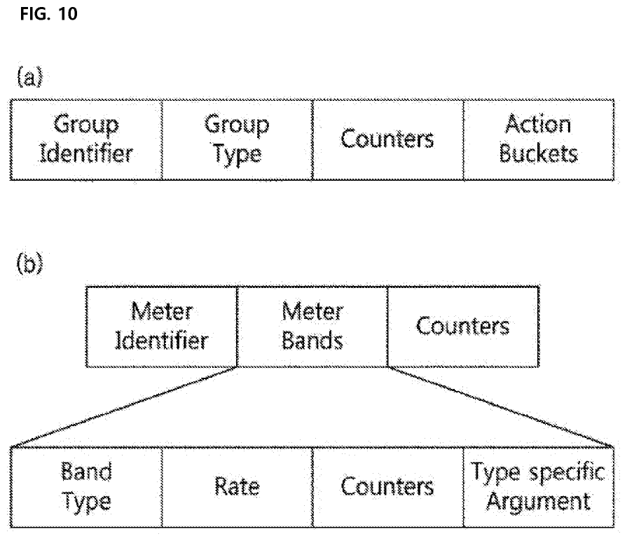

The group table may include group entries. The group table may be instructed by the flow entry to propose additional forwarding schemes. Referring to FIG. 10(a), the group entry of the group table may include the following fields. The group entry may include: a group identifier that may distinguish the group entry; a group type that specifies a rule on whether to perform some or all of action buckets defined in the group entry; counters for statistics, such as counters of the flow entry; and action buckets that are a set of actions associated with parameters defined for a group.

The meter table may include meter entries, and may define per-flow meters. The per-flow meters may allow various QoS operations to be applied to the openflow. A meter is a kind of switch element that may measure and control a rate of packets. Referring to FIG. 10(b), the meter table may include fields such as: a meter identifier that identifies a meter; meter bands that represent a speed and a packet operation scheme designated for a band; and counters that are updated when a packet operates in the meter. The meter bands may include fields such as: a band type that represents a processing scheme of a packet; a rate used to select a meter band by a meter; counters that are updated when packets are processed by the meter band; and a type specific argument that represents bad types having a selective argument.

The switch control unit 200 may control an overall operation of the switch 20 by controlling an operation of each of the units. The control unit 200 may include a table management module 240 configured to manage a table 291, a flow searching module 220, a flow processing module 230, and a packet processing module 235. Each of the modules may be configured as hardware within the control unit 200, or may be configured as software separate from the control unit 200.

The table management module 240 may add an entry received from the SDN controller 10 through the SDN controller communication unit 210 to an appropriate table, or may periodically remove a time-out entry.

The flow searching module 220 may extract flow information from the received packet as a user traffic. The flow information may include: identification information of an ingress port that is a packet incoming port of an edge switch; identification information of the packet incoming port of the switch; packet header information (an IP address, a MAC address, a port, VLAN information of a transmission source and a destination, etc.); metadata; and the like. The metadata may be data selectively added from a previous table or added from another switch. The flow searching module 220 may search for whether there is a flow entry for the received packet in the table 291 with reference to the extracted flow information. When the flow entry is retrieved, the flow searching module 220 may request the flow processing module 230 to process the received packet according to the retrieved flow entry. If the searching of the flow entry fails, the flow searching module 220 may transmit the received packet or minimum data of the received packet to the SDN controller 10 through the SDN controller communication unit 210.

The flow processing module 230 may process an action for outputting a packet to a specific port or multiple ports according to a procedure described in the entry retrieved by the flow searching module 220, dropping the packet, modifying a specific header field, or the like.

The flow processing module 230 may process a pipeline process of a flow entry, execute an instruction for changing an action, or execute an action set when it is no longer possible to go to a next table in the multiple flow tables.

The packet processing module 235 may actually output the packet processed by the flow processing module 230 to one port or two or more ports of the port unit 205 designated by the flow processing module 230.

Although not shown in FIG. 1, the SDN network system may further include an orchestrator configured to generate, change, and delete a virtual network device, a virtual switch, and the like. When the virtual network device is generated, the orchestrator may provide information of the network device, such as identification information of a switch to which the virtual network is to be accessed, identification information of a port connected to the switch, a MAC address, an IP address, tenant identification information, and network identification information, to the SDN controller 10.

The SDN controller 10 and the switch 20 may exchange various information, which is referred to as an openflow protocol message. Such an openflow message may be classified by types, such as an SDN controller-to-switch message, an asynchronous message, and a symmetric message. Each of the messages may include a transaction ID (xid) that identifies an entry in a header.

The SDN controller-to-switch message is a message generated by the SDN controller 10 so as to be forwarded to the switch 20, and may be mainly used to manage or check a state of the switch 20. The SDN controller-to-switch message may be generated by the control unit 100 of the SDN controller 10, especially by the message management module 130.

The SDN controller-to-switch message may include: features for inquiring capabilities of the switch; a configuration for inquiring and setting a setting of a configuration parameter or the like of the switch 20; a modify state message for adding/deleting/modifying flow/group/meter entries in the openflow table; a packet-out message that allows the packet received from the switch through the packet-in message to be transmitted to a specific port on the switch; and the like. The modify state message may include a modify flow table message, a modify flow entry message, a modify group entry message, a port modification message, a meter modification message, and the like.

The asynchronous message is a message generated by the switch 20, and may be used to update switch state modification, a network event, and the like in the SDN controller 10. The asynchronous message may be generated by the control unit 200 of the switch 20, especially by the flow searching module 220.

The asynchronous message may include a packet-in message, a flow-removed message, an error message, and the like. The packet-in message may be used to allow the switch 20 to transmit a packet to the SDN controller 10 so as to receive a control over the packet. The packet-in message is a message including the received packet transmitted from the openflow switch 20 to the SDN controller 10 or all or a part of a copy of the received packet in order to request a data path when the switch 20 receives an unknown packet. The packet-in message may also be used even when the action of the entry associated with the incoming packet is determined to be forwarded to the SDN controller. The flow-removed message may be used to forward information of a flow entry, which is to be deleted from the flow table, to the SDN controller 10. This message may be generated when the SDN controller 10 requests the switch 20 to delete the flow entry, or flow expiry processing due to a flow timeout is performed.

The symmetric message may be generated by both the SDN controller 10 and the switch 20, and may be transmitted even when there is no request from an opposite side. The symmetric message may include: “hello” used to initiate connection between the SDN controller and the switch;“echo” used to confirm that there is no abnormality in the connection between the SDN controller and the switch; an error message used by the SDN controller or the switch to inform the opposite side of a problem; and the like. Most of the error messages may be used by the switch to represent a failure according to the request initiated by the SDN controller.

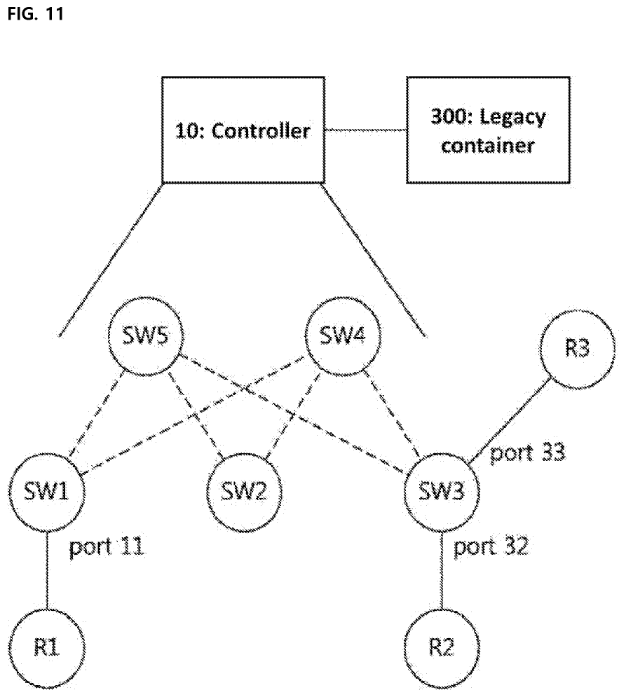

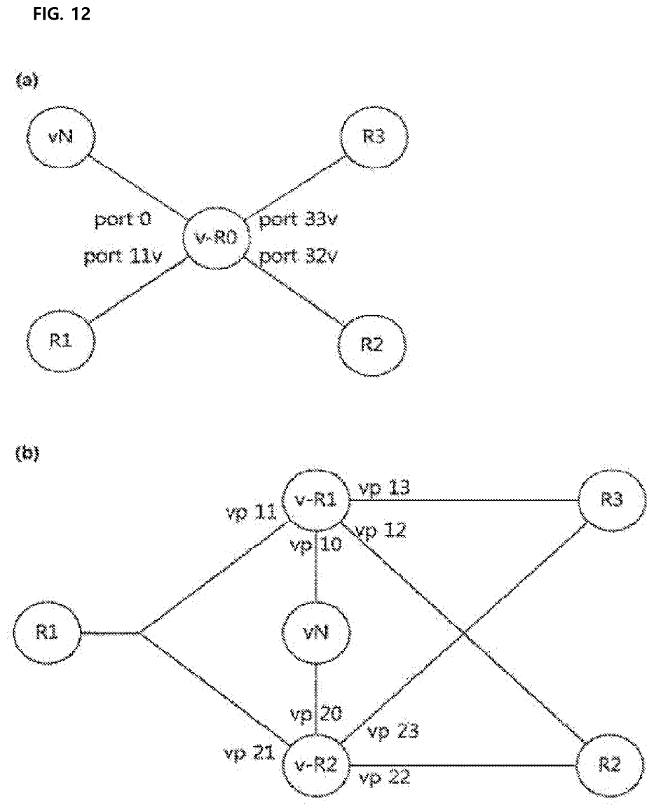

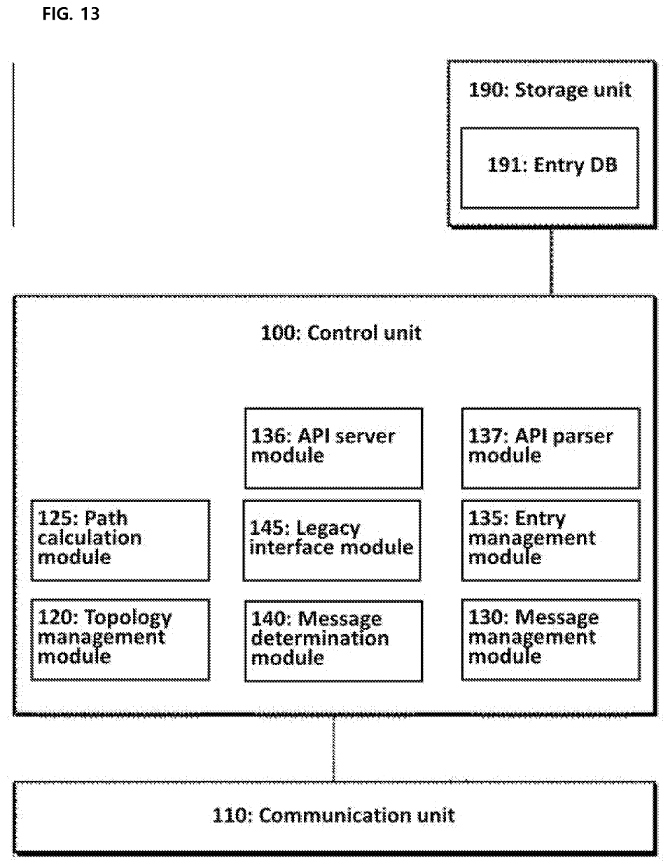

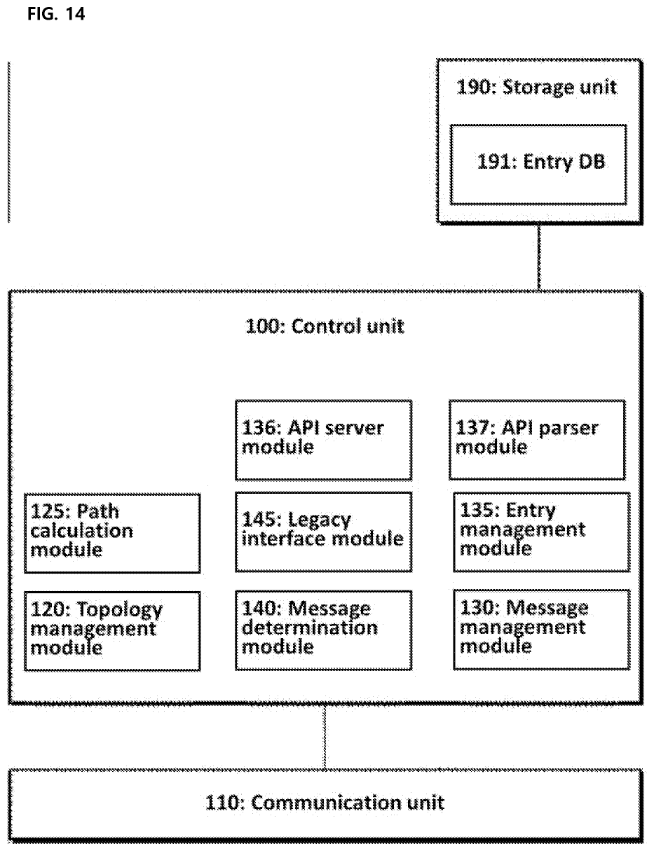

FIG. 11 is a block diagram showing a network system including an integrated routing system according to one embodiment of the present invention, FIG. 12 is a virtualized block diagram showing the network system of FIG. 11, FIG.13 is a block diagram showing an SDN controller according to another embodiment of the present invention, and FIG.14 is a block diagram showing a legacy routing container according to one embodiment of the present invention.

A network shown in FIG. 11 may be configured by combining an SDN-based network including an SDN controller 10 configured to control a flow of an openflow switch of a switch group including a plurality of switches SW1 to SW5, and a legacy network of first to third legacy routers R1 to R3. In the present specification, the SDN-based network refers to an independent network including only an openflow switch, or including an openflow switch and an existing switch. When the SDN-based network includes an openflow switch and an existing switch, the SDN-based network desirably includes an openflow switch disposed at an edge of a network domain in the switch group.

Referring to FIG. 11, according to the present invention an SDN-based integrated routing system may include a switch group including first to fifth switches SW1 to SW5, an SDN controller 10, and a legacy routing container 300. Detailed descriptions of identical or similar elements are given with reference to FIGS. 1 to 8.

The first and third switches SW1 and SW3, which are edge switches connected to an external network among first to fifth switches SW1 to SW5, are openflow switches that support the openflow protocol. The openflow switch may be in a form of physical hardware, virtualized software, or a combination of hardware and software.

In the present embodiment, the first switch SW1 is an edge switch connected to the first legacy router R1 through an eleventh port port 11, and the third switch SW3 is an edge switch connected to the second and third legacy routers R2 and R3 through thirty-second and thirty-third ports port 32 and port 33. The switch group may further include a plurality of network devices (not shown) connected to the first to fifth switches.

Referring to FIG. 13, the SDN controller 10 may include a switch communication unit 110 configured to communicate with the switch 20, a control unit 100, and a storage unit 190.

The control unit 100 of the SDN controller may include a topology management module 120, a path calculation module 125, an entry management module 135, a message management module 130, and a legacy interface module 145. Each of the modules may be configured as hardware within the control unit 100, or may be configured as software separate from the control unit 100. Descriptions of elements with the same reference numeral are given with reference to FIG. 6.

When the switch group includes only an openflow switch, functions of the topology management module 120 and the path calculation module 125 may be the same as the functions described with reference to FIGS. 1 to 8. When the switch group includes an openflow switch and an existing legacy switch, the topology management module 120 may acquire access information with the legacy switch through the openflow switch.

The legacy interface module 145 may communicate with the legacy routing container 300. The legacy interface module 145 may transmit topology information of the switch group constructed by the topology management module 120 to the legacy routing container 300. The topology information may include access relation information of the first to fifth switches SW1 to SW5, and connection or access information of a plurality of network devices connected to the first to fifth switches SW1 to SW5.

When the message management module 130 may not generate a flow processing rule provided in a flow inquiry message received from the openflow switch, the message management module 130 may transmit the flow to the legacy routing container 300 through the legacy interface module 145. The flow may include a packet received from the openflow switch, and port information of the switch that has received the packet. A case where the flow processing rule may not be generated may include: a case where the received packet is configured by a legacy protocol so as not to be interpreted; a case where the path calculation module 125 may not calculate a path for a legacy packet; and the like.

Referring to FIG. 14, the legacy routing container 300 may include an SDN interface module 345, a virtual router generation unit 320, a virtual router 340, a routing processing unit 330, and a routing table 335.

The SDN interface module 345 may communicate with the SDN controller 10. The legacy interface module 145 and the SDN interface module 345 may serve as interfaces of the SDN controller 10 and the legacy routing container 300, respectively. The legacy interface module 145 and the SDN interface module 345 may communicate with each other in a specific protocol or a specific language. The legacy interface module 145 and the SDN interface module 345 may translate or interpret a message exchanged between the SDN controller 10 and the legacy routing container 300.

The virtual router generation unit 320 may generate and manage the virtual router 340 by using the topology information of the switch group received through the SDN interface module 345. The switch group may be treated as a legacy router in an external legacy network, that is, in the first to third routers R1 to R3, through the virtual router 340.

The virtual router generation unit 320 may generate a plurality of virtual routers 340. FIG. 12(a) shows a case of a virtual legacy router v-R0 in which one virtual router 340 is provided, and FIG. 12(b) shows a case of a plurality of virtual legacy routers v-R1 and v-R2 in which a plurality of virtual routers 340 are provided.

The virtual router generation unit 320 may allow the virtual router 340 to include a router identifier, for example, a lookback IP address.

The virtual router generation unit 320 may allow the virtual router 340 to include a port for a virtual router corresponding to edge ports of the edge switches of the switch group, that is, the first and third edge switches SW1 and SW3. For example, as in the case of FIG. 12(a), a port of a v-R0 virtual legacy router may use information of the eleventh port port 11 of the first switch SW1, and the thirty-second and thirty-third ports port 32 and port 33 of the third switch SW3.

The port of the virtual router 340 may be associated with the identification information of the packet. The identification information of the packet may be tag information such as vLAN information of a packet, and a tunnel ID added to the packet when access is performed through a mobile communication network. In this case, a plurality of virtual router ports may be generated with one actual port of the openflow edge switch. The virtual router port associated with the identification information of the packet may contribute to allowing the virtual router 340 to operate as a plurality of virtual legacy routers. When the virtual router is generated only with a physical port (an actual port) of the edge switch, a number of physical ports may be limited. However, when the virtual router port is associated with the identification information of the packet, such a limitation is removed. In addition, the virtual router port may operate similarly to the flow in the legacy network of the existing packet. Further, the virtual legacy router may be driven for each user or for each user group. The user or the user group may be classified by the packet identification information such as a vLAN or a tunnel ID. Referring to FIG. 12(b), the switch group may be virtualized with a plurality of virtual legacy routers v-R1 and v-R2, and each of ports vp 11 to 13 and vp 21 to 23 of the virtual legacy routers v-R1 and v-R2 may be associated with the identification information of the packet.

Referring to FIG. 12(b), the virtual legacy routers v-R1 and v-R2 and the legacy router may be accessed by a plurality of sub-interfaces divided from one actual interface of the first legacy router R1, or by a plurality of actual interfaces such as the second and third legacy routers R2 and R3.

The virtual router generation unit 320 may allow a plurality of network devices in which the first to third routers R1 to R3 are connected to the first to fifth switches SW1 to SW5 to be treated as an external network vN connected to the virtual router 340. Accordingly, the legacy network may access network devices of an openflow switch group. In the case of FIG. 12(a), the virtual router generation unit 320 may generate a zeroth port port 0 in a zeroth virtual legacy router v-R0. In the case of FIG. 12(b), the virtual router generation unit 320 may generate tenth and twentieth ports vp 10 and vp 20 in the first and second virtual legacy routers v-R1 and v-R2. Each of the generated ports port 0, vp 10, and vp 20 may have information that may be obtained as in a case where a plurality of network devices of a switch group are connected. The external network vN may include all or some of the network devices.

Information of the ports port 0, port 11v, port 32v, port 33v, vp 10 to 13, and vp 20 to 23 for the virtual router may have port information of the legacy router. For example, information of the port for the virtual router may include a MAC address, an IP address, a port name, an address range of the connected network, and legacy router information of each virtual router port, and may further include a vLAN range, a tunnel ID range, and the like. Such port information may inherit edge port information of the first and third edge switches SW1 and SW3 as described above, or may be designated by the virtual router generation unit 320.

A data plane of the network of FIG. 11, which is generated in the virtual router 340 by the virtual router 340, may be virtualized as shown in FIG. 12(a) or FIG. 12(b). For example, in the case of FIG. 12(a), according to the virtualized network, the first to fifth switches SW1 to SW5 may be virtualized by the virtual legacy router v-R0. The eleventh v, thirty-second v, and thirty-third v ports port 11v, 32v, and 33v of the zeroth virtual legacy router v-R0 may be connected to the first to third legacy routers R1 to R3, and the zeroth port port 0 of the zeroth virtual legacy router v-R0 may be connected to the external network vN that includes at least some of the network devices.

The routing processing unit 330 may generate the routing table 335 when the virtual router 340 is generated. The routing table 335 is a table used to be referenced to the routing in the legacy router. The routing table 335 may include some or all of RIB, FIB, and ARP tables. The routing table 335 may be modified or updated by the routing processing unit 330.

The routing processing unit 330 may generate a legacy routing path for a flow inquired from the SDN controller 10. The routing processing unit 330 may generate legacy routing information by using some or all of the received packet received from the openflow switch provided in the flow, the information of the port to which the received packet incomes, the information of the virtual router 340, the routing table 335, and the like.

The routing processing unit 330 may include a third party routing protocol stack to determine the legacy routing.

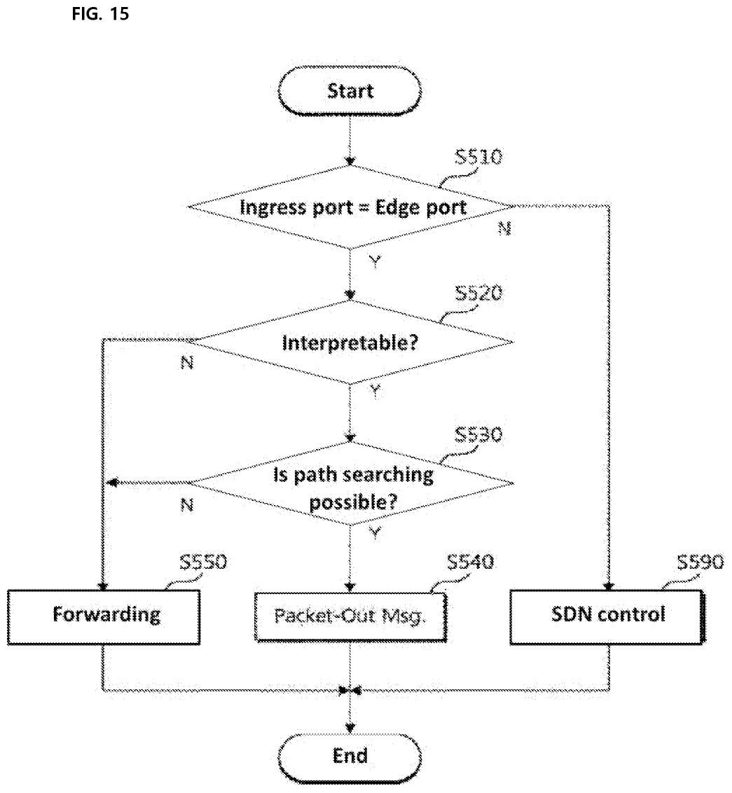

FIG. 15 is a flowchart showing a method of determining legacy routing for a flow of the SDN controller of FIG. 11. Descriptions will be given with reference to FIGS. 11 to 14.

A method of determining legacy routing of a flow means whether the SDN controller 10 performs normal SDN control on the flow received from the openflow switch, or inquires the legacy routing container 300 about flow control.

Referring to FIG. 15, the SDN controller 10 may determine whether a flow ingress port is an edge port (S510). When the flow ingress port is not an edge port, the SDN controller 10 may perform SDN-based flow control, such as calculating a path for a normal openflow packet (S590).

When the flow ingress port is an edge port, the SDN controller 10 may determine whether a packet of the flow is interpretable (S520). When the packet is not interpretable, the SDN controller 10 may forward the flow to the legacy routing container 300 (S550). This is because when the packet is a protocol message that is used only in the legacy network, a normal SDN-based SDN controller may not interpret the packet.

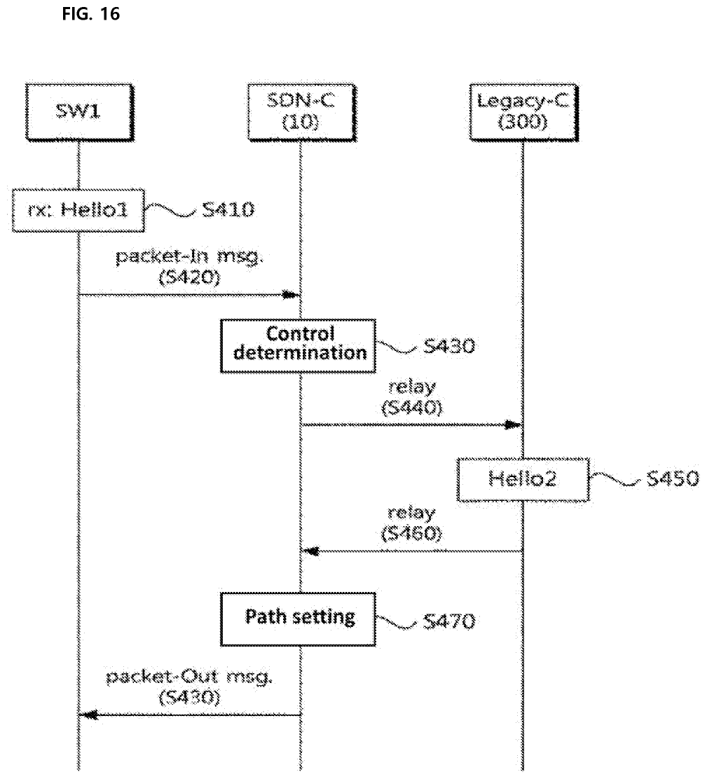

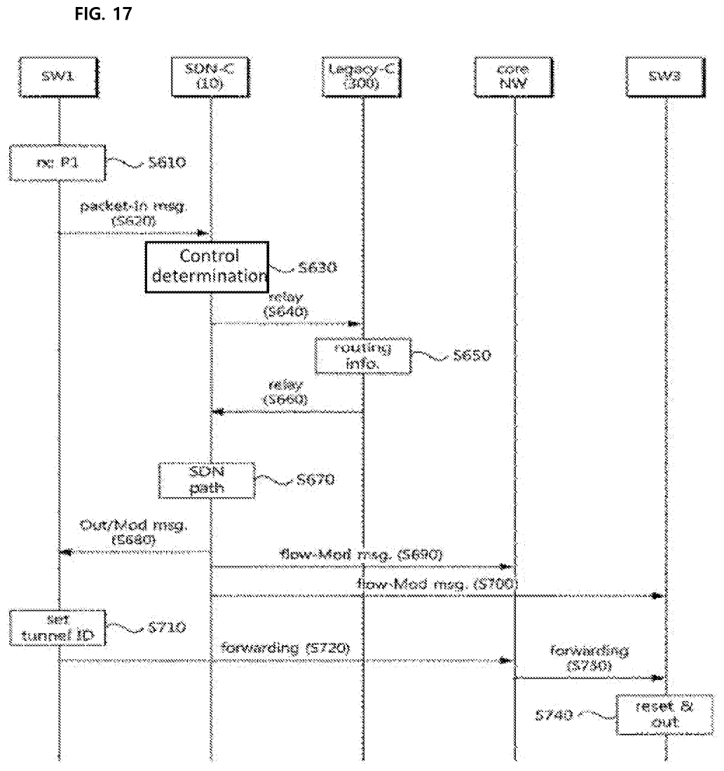

When the received packet is a legacy packet such as a packet transmitted from a first legacy network to a second legacy network, the SDN-based SDN controller 10 may not calculate a routing path of the incoming legacy packet. Therefore, when the path may not be calculated by the SDN controller 10 as in the case of the legacy packet, the SDN controller 10 desirably forwards the legacy packet to the legacy routing container 300. However, when an edge port from which the legacy packet is to exit and a final processing scheme of the legacy packet are identified, the SDN controller 10 may process the legacy packet through flow modification. Accordingly, when the packet is interpretable, the SDN controller 10 may search for a path of the flow such as whether the path of the flow may be calculated or whether there is an entry in the entry table (S530). When the path may not be retrieved, the SDN controller 10 may forward the flow to the legacy routing container 300 (S550). When the path may be retrieved, the SDN controller 10 may generate a packet-out message that indicates an output of the packet to transmit the packet-out message to an openflow switch that has inquired the packet (S540). A detailed example thereof will be described below with reference to FIGS. 16 and 17.

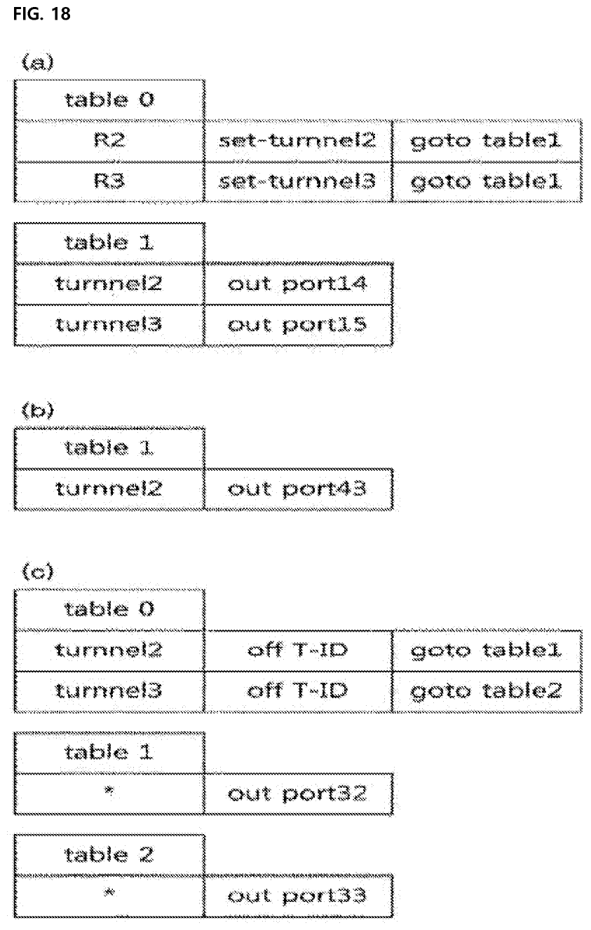

FIG. 16 is a signal flowchart showing an integrated routing method according to one embodiment of the present invention, FIG. 17 is a signal flowchart showing an integrated routing method according to another embodiment of the present invention, and FIG. 18 is a flow table according to one embodiment of the present invention. Descriptions will be given with reference to FIGS. 11 to 15.

FIG. 16 shows a flow of processing a legacy protocol message in an SDN-based network to which the present invention is applied. As one example of the flow, in FIG. 16, the first edge switch SW1 may receive a hello message of an open shortest path first (OSPF) protocol.

In the present example, it is assumed that the openflow switch group is virtualized by the SDN controller 10 and the legacy routing container 300 as shown in FIG. 12(a).

Referring to FIG. 16, when the first legacy router R1 and the first edge switch SW1 are connected, the first legacy router R1 may transmit a hello message Hello1 of the OSPF protocol to the first edge switch SW1 (S410).

Since there is no flow entry for the received packet in the table 291 of the first edge switch SW1, the first edge switch SW1 may transmit a packet-in message, which informs an unknown packet, to the SDN controller 10 (S420). The packet-in message desirably includes a flow including information of a Hello1 packet and an ingress port port 11.

The message management module 130 of the SDN controller 10 may determine whether a processing rule for the flow is generable (S430). Details of the determining method are described with reference to FIG. 15. In the present example, the OSPF protocol message is a packet that may not be interpreted by the SDN controller 10, so that the SDN controller 10 may forward the flow to the legacy routing container 300 (S440).

The SDN interface module 345 of the legacy routing container 300 may transmit the Hello1 packet forwarded from the SDN controller 10 to the port port 11v of the virtual router 340 corresponding to the ingress port port 11 of the first edge switch SW1 provided in the flow. When the virtual router 340 receives the Hello1 packet, the routing processing unit 330 may generate legacy routing information of the Hello1 packet based on the routing table 335 (S450). In the present embodiment, the routing processing unit 330 may generate a Hello2 message corresponding to the Hello1 message, and generate a routing path that designates the eleventh v port port 11v as an output port to transmit the Hello2 packet to the first legacy router R1. The Hello2 message may include a destination that is the first legacy router R1 and a predetermined virtual router identifier. The legacy routing information may include a Hello2 packet and an output port that is the eleventh v port. Although the Hello1 packet has been described in the present embodiment as being introduced into the virtual router 340, the present invention is not limited thereto, and the routing processing unit 330 may generate the legacy routing information by using the information of the virtual router 340.

The SDN interface module 345 may forward the generated legacy routing information to the legacy interface module 145 of the SDN controller 10 (S460). Any one of the SDN interface module 345 and the legacy interface module 145 may convert the eleventh v port port 11v, which is the output port, into an eleventh port port 11 of the first edge switch SW1. Alternatively, the port conversion may be omitted by setting names of the eleventh v port and the eleventh port to be the same.

The path calculation module 125 of the SDN controller 10 may set a path for outputting the Hello2 packet to the eleventh port port 11 of the first legacy router R1 by using the legacy routing information received through the legacy interface module 145 (S470).

The message management module 130 may generate a packet-out message for outputting the Hello2 packet to the eleventh port port 11, which is an ingress port, by using the set path and the legacy routing information to transmit the packet-out message to the first legacy router R1 (S480).

Although it has been described in the present embodiment as corresponding to the Hello message of the external legacy router, the present invention is not limited thereto. For example, the legacy routing container 300 may generate an OSPF hello message that allows active output to the edge port of the edge switch to transmit the OSPF hello message to the SDN controller 10. In this case, the SDN controller 10 may transmit the Hello packet to the openflow switch as a packet-out message. In addition, even when the packet-out message does not correspond to the packet-in message, the present embodiment may be implemented by setting the openflow switch to operate as being instructed by the packet-out message.

FIG. 17 shows a case where a normal legacy packet is transmitted from the first edge switch SW1 to the third edge switch SW3.

The first edge switch SW1 may start by receiving a legacy packet P1 in which a destination IP address does not belong to the openflow switch group from the first legacy router R1 (S610).

Since there is no flow entry for the packet P1, the first edge switch SW1 may transmit the packet P1 to the SDN controller 10 and inquire the flow processing (packet-in message) (S620).

The message management module 130 of the SDN controller 10 may determine whether SDN control for the flow is possible (S630). In the present example, although the packet P1 is interpretable, since the packet P1 is directed to the legacy network, the SDN controller 10 may not generate the path for the packet P1. Accordingly, the SDN controller 10 may transmit the packet P1 and the eleventh port, which is an ingress port, to the legacy routing container 300 through the path calculation module 125 (S640).

The routing processing unit 330 of the legacy routing container 300 may generate legacy routing information of the packet P1 forwarded from the SDN controller 10 based on the information of the virtual router 340 and the routing table 335 (S650). In the present example, it is assumed that the packet P1 needs to be output to a thirty-second v port port 32v of the virtual router. In this case, the legacy routing information may include an output port, which is the thirty-second v port port 32v, a destination MAC address, which is a MAC address of the second legacy router R2, and a source MAC address, which is a MAC address of the thirty-second v port, with respect to the packet P1. Such information is header information of the packet output from the legacy router. For example, when the first legacy router R1 transmits the packet P1 by considering the virtual legacy router v-R0 as a legacy router, the header information of the packet P1 may be as follows. Since the source and destination IP addresses are the same as the source and destination IP addresses in the header information when the packet P1 is generated, descriptions thereof will be omitted. The source MAC address of the packet P1 is a MAC address of an output port of the router R1. The destination MAC address of the packet P1 is a MAC address of the eleventh v port port 11v of the virtual legacy router v-R0. In the case of an existing router, a packet P1′ output to the thirty-second v port port 32v of the virtual legacy router v-R0 may have the following header information. The source MAC address of the packet P1′ is a MAC address of the thirty-second v port port 32v of the virtual legacy router v-R0, and the destination MAC address is a MAC address of the ingress port of the second legacy router. In other words, a part of the header information of packet P1 may be changed during the legacy routing.

In order to correspond to the legacy routing, the routing processing unit 330 may generate the packet P1′ obtained by adjusting the header information of the packet P1, and include the packet P1′ in the legacy routing information. In this case, the SDN controller 10 or the legacy routing container 300 needs to process the ingress packet every time for the same packet or a similar packet having the same destination address range. Therefore, in a step of changing of a packet to have a format after the existing routing, packet manipulation is desirably performed by the edge switch (the third edge switch SW3 in the present example) that outputs the packet to the external legacy network, rather than the legacy routing container 300. To this end, the legacy routing information described above may include source and destination MAC addresses. The SDN controller 10 may transmit a flow-Mod message for changing the header information of the packet P1′ to the third edge switch by using the routing information.

The SDN interface module 345 may forward the generated legacy routing information to the legacy interface module 145 of the SDN controller 10 (S660). In the present step, the output ports may be converted into an edge port to be mapped.

The path calculation module 125 of the SDN controller 10 may calculate a path that is output from the first edge switch SW1 to the thirty-second port of the third edge switch SW3 by using the legacy routing information received through the legacy interface module 145(S670).

The message management module 130 may transmit a packet-out message that designates an output port for the packet P1 to the first edge switch SW1 based on the calculated path (S680), and may transmit a flow-Mod message to the openflow switch of the path (S690 and S700). The message management module 130 may also transmit a flow-Mod message for specifying the processing for the same flow to the first edge switch SW1.

The flow processing for the packet P1 is desirably performed based on an identifier for identifying the legacy flow. To this end, the packet-out message transmitted to the first edge switch SW1 may include the packet P1 to which a legacy identifier tunnel ID is added, and a flow modification message may include a flow entry for adding the legacy identifier tunnel ID. One example of a flow table of each of the switches is shown in FIG. 18. FIG. 18(a) is a flow table of the first edge switch SW1. For example, in a table 0 of FIG. 18(a), tunnel2 may be added to the flow directed to the second legacy router R2 as a legacy identifier, and the flow may move to a table 1. The legacy identifier may be written in a metafield or other fields. A table 1 may include a flow entry for outputting a flow having tunnel2 to a fourteenth port (port information of the first switch SW1 connected to the fourth switch SW4). FIG. 18(b) is an example of a flow table of the fourth switch SW4. In the table of FIG. 18(b), the flow having the legacy identifier of tunnel2 among the flow information may be output to the forty-third port port 43 connected to the third switch SW3. FIG. 18(c) is an example of a flow table of the third switch SW3. In a table 0 of FIG. 18(c), the legacy identifier of the flow having the legacy identifier of tunnel2 may be removed, and the flow may move to a table 1. The table 1 may output the flow to the thirty-second port. As described above, when multiple tables are used, a number of cases may be reduced. This may enable rapid search, and may reduce consumption of resources such as a memory.

The first edge switch SW1 may add the legacy identifier tunnel ID to the packet P1 (S710), or transmit a packet to which the legacy identifier tunnel ID is added to a core network (S720). The core network refers to a network including the openflow switches SW2, SW4, and SW5 rather than the edge switches SW1 and SW3.

The core network may transmit the flow to the third edge switch SW3 (S730). The third edge switch SW3 may remove the legacy identifier, and output the packet P1 to a designated port (S740). In this case, although not shown in the flow table of FIG. 18, the flow table of the third switch SW3 desirably includes a flow entry for changing the destination and source MAC addresses of the packet P1.

The present invention may be implemented in hardware or software. With regard to the implementation, the present invention may also be implemented as a computer-readable code in a computer-readable recording medium. The computer-readable recording medium includes all types of recording devices for storing data that may be read by a computer system. Examples of the computer-readable recording medium include a ROM, a RAM, a CD-ROM, a magnetic tape, a floppy disk, an optical data storage device, and the like, and also include those implemented in the form of a carrier wave (e.g., transmission through the Internet). In addition, the computer-readable recording medium may be distributed in computer systems connected through a network, so that the computer-readable code may be stored and executed in a distributed manner. Further, functional programs, codes, and code segments for implementing the present invention may be easily inferred by programmers in the art to which the present invention pertains.

The embodiments of the present invention may include a carrier wave having electronically-readable control signals that may be operated by a programmable computer system in which one of the methods described above is executed. The embodiments of the present invention may be implemented as a computer program product having a program code, and the program code is operated to execute one of the methods when the computer program is run on a computer. For example, the program code may be stored on a machine-readable carrier. When the computer program is run on the computer, one embodiment of the present invention may be a computer program having a program code for executing one of the methods described herein. The present invention may include a computer, or a programmable logic device for executing one of the methods described above. The programmable logic device (e.g., a field programmable gate array and a complementary metal oxide semiconductor-based logic circuit) may be used to execute some or all of the functions of the methods described above.

[1] In addition, although the exemplary embodiments of the present invention have been illustrated and described above, the present invention is not limited to a specific embodiment described above. Various modifications may be made by those of ordinary skill in the art to which the present invention pertains without departing from the gist of the present invention as claimed in the claims, and such modified embodiments should not be separately understood from the technical idea or prospect of the present invention.

1. An open fronthaul device comprising:
a software defined network (SDN) controller including a plurality of openflow edge switches connected to a plurality of legacy networks, which are wireless access networks or wired access networks, in which the openflow edge switches are configured to acquire information of the openflow edge switches belonging to a switch group; and
a legacy routing container configured to treat a switch group including at least some switches among the switches as a virtual router to generate routing information for a packet introduced into any one switch of the switch group, wherein the legacy routing container is configured to map a plurality of network devices, which are connected to the openflow switches configured to generate legacy routing information for a flow processing inquiry message of the controller based on information of at least one virtual router, with information of an external network that is directly connected to the virtual router.

2. The open fronthaul device of claim 1, wherein the controller further includes a virtual wireless network control module configured to map an RRH device of the connected wireless access network with the information of the external network that is directly connected to the virtual router.

3. The open fronthaul device of claim 1, wherein the controller further includes a virtual wired network control module configured to map an OLT of the connected wired access network with the information of the external network that is directly connected to the virtual router.

4. The open fronthaul device of claim 1, wherein the controller further includes a distributed wireless network control module configured to map a digital processing unit (digital unit; DU) of the connected wireless access network with the information of the external network that is directly connected to the virtual router.

5. The open fronthaul device of claim 1, wherein the controller further includes:
a port management module configured to map a logical port of the switch with a physical port of the switch;
a legacy interface module configured to communicate with the legacy routing container; and
an API server module configured to perform an operation according to a procedure of changing information of the mapped network device.
